(19) United States
(12) Patent Application Publication
(10) Pub. No.: US 2026/0073678 A1
(43) Pub. Date: Mar. 12, 2026

(54) MULTIPLEXED METASURFACE OPTICAL NEURAL NETWORKS

(71) Applicant: Northeastern University, Boston, MA (US)

(72) Inventors: Yongmin Liu, Chestnut Hill, MA (US); Yihao Xu, Boston, MA (US); Alexander Monte McNeil, Hull, MA (US); Yuxiao Li, Everett, MA (US)

(21) Appl. No.: 19/323,989

(22) Filed: Sep. 9, 2025

Related U.S. Application Data
(60) Provisional application No. 63/692,837, filed on Sep. 10, 2024.

(51) Int. Cl. G06V 10/88; G02B 1/00; G02B 27/00; G06N 3/067; G06V 10/143; G06V 10/147; G06V 10/764; G06V 10/82; G06V 30/14; G06V 30/19; G06V 30/22

(52) U.S. Cl. CPC G06V 10/88; G02B 1/002; G02B 27/0012; G06N 3/067; G06V 10/143; G06V 10/147; G06V 10/764; G06V 10/82; G06V 30/1429; G06V 30/19173; G06V 30/22

(57) ABSTRACT

The present disclosure provides a multiplexed metasurface optical neural network device including metasurface layers that modify amplitude and phase of incident light to perform distinct classification tasks, each task associated with a degree of freedom including wavelength or polarization, and a detector that captures output intensity information encoding classification weights. A method includes projecting light intensity profiles representing objects onto metasurface layers using different wavelengths or polarization states, and capturing output intensity information corresponding to classification into different sets of classes. The device enables handwritten digit recognition at one wavelength or polarization state and object classification at another. The device also operates as a generative model, with metasurface layers generating diverse output images in response to random input light intensity profiles through spatial multiplexing, where random profiles are derived from a standard Gaussian distribution representing latent variables.

### CROSS-REFERENCE TO RELATED APPLICATIONS

This application claims priority to U.S. Provisional Patent Application No. 63/692,837, titled MULTIPLEXED METASURFACE OPTICAL NEURAL NETWORKS, filed Sep. 10, 2024, which is hereby incorporated by reference in its entirety.

### FIELD OF INVENTION

The present disclosure relates to optical neural networks, and more particularly to multiplexed metasurface optical neural networks that perform multiple distinct classification tasks and generative functions using wavelength, polarization, and spatial multiplexing.

### BACKGROUND

Artificial neural networks (ANNs) have become fundamental tools for processing and understanding large amounts of data across various applications. Traditional electronic implementations of ANNs face limitations in terms of power consumption and processing speed, leading to growing interest in optical neural networks (ONNs) as an alternative approach. ONNs offer potential advantages in power efficiency, speed, parallelism, bandwidth, and scalability compared to their electronic counterparts.

Optical neural networks can be implemented using various approaches, including integrated photonic platforms, diffractive optical elements, and metasurface-based architectures. Metasurfaces, which consist of arrays of subwavelength nanostructures, provide precise control over various characteristics of incident light, such as amplitude, phase, and polarization of light. These structures can be designed to perform optical computations by manipulating light as it propagates through the system. Current optical neural network implementations typically operate with limited multiplexing capabilities and may be restricted to specific wavelengths or polarization states, which can limit their functional versatility in processing multiple types of data simultaneously.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In a first aspect, the technology provides a multiplexed metasurface optical neural network device comprising one or more metasurface layers that modify amplitude and phase of incident light, the metasurface layers performing a plurality of distinct classification tasks, each task associated with a degree of freedom of the incident light such as wavelength or polarization, and a detector that captures output intensity information encoding classification weights for each of the plurality of distinct classification tasks.

In some embodiments, each of the one or more metasurface layers has distinct amplitude and phase profiles optimized for multiplexing. In yet other embodiments, the plurality of distinct classification tasks comprise between 6 and 12, or more, distinct classification tasks. In some embodiments, the detector comprises a CCD camera that captures intensity information encoding digit weights.

In other embodiments, the metasurface layers are trained independently for each wavelength by optimizing amplitude and phase modifications through multiple iterations using Fresnel diffraction calculations, wherein the training process may account for various characteristics of light including polarization states, coherence properties, spectral bandwidth variations, and temporal coherence parameters. In some embodiments, a first wavelength performs handwritten digit recognition and a second wavelength performs classification of objects, such as fashion objects. In one specific embodiment, the first wavelength is about 700 nm and the second wavelength is about 1100 nm. In general, however, wavelengths across a broad spectral range, from the visible to the infrared, may be used. In other embodiments, the metasurface layers comprise dielectric nanostructures. In other embodiments, the dielectric nanostructures control both amplitude and phase of the incident light to enable all-optical image classification at different wavelengths.

In a second aspect, the technology provides a method of operating a multiplexed metasurface optical neural network device comprising projecting a first light intensity profile representing a first object onto metasurface layers using a first degree of freedom of light such as wavelength or polarization, capturing first output intensity information from the metasurface layers corresponding to classification of the first object into a first set of classes, projecting a second light intensity profile representing a second object onto the metasurface layers using a second degree of freedom of light different from the first degree of freedom, such as a different wavelength or polarization, and capturing second output intensity information from the metasurface layers corresponding to classification of the second object into a second set of classes different from the first set of classes.

In some embodiments, the method further comprises classifying the first object based on the first output intensity information and classifying the second object based on the second output intensity information. In some embodiments, the degree of freedom of light is the wavelength or polarization state which can be selected from a broad spectral range from visible to infrared for wavelength multiplexing or from various polarization states including linear, circular, and elliptical for polarization multiplexing. In specific of these embodiments, the first wavelength is about 700 nm and the second wavelength is about 1100 nm. In some embodiments, the first set of classes comprises handwritten digits and the second set of classes comprises objects, such as fashion objects. In general, however, the method can be applied to any classification tasks using appropriate image data for training. In other embodiments, the classification of handwritten digits and the classification of objects achieves an accuracy in excess of a predetermined threshold. In some embodiments, the one or more metasurface layers modify both amplitude and phase of the incident light. In other embodiments, each of the one or more metasurface layers has distinct amplitude and phase profiles optimized independently for each degree of freedom of light including wavelength or polarization through Fresnel diffraction calculations. In some embodiments, capturing the first output intensity information and capturing the second output intensity information comprises using a CCD camera that captures intensity information encoding classification weights. In other embodiments, the metasurface layers comprise dielectric nanostructures that control both amplitude and phase of the incident light. In yet other embodiments, the dielectric nanostructures enable all-optical image classification through metasurface multiplexing at the different degrees of freedom of incident light including wavelength multiplexing or polarization multiplexing.

In a third aspect, the technology provides a multiplexed metasurface optical neural network device comprising a plurality of metasurface layers that modify amplitude and phase of incident light, and a detector that captures output images, the metasurface layers generating diverse output images in response to random input light intensity profiles through spatial multiplexing, the random input light intensity profiles being derived from a standard Gaussian distribution representing latent variables in a generative model.

In some embodiments, each of the one or more metasurface layers has distinct phase profiles optimized for the generative model through spatial multiplexing. In some embodiments, the device operates as a decoder in a variational autoencoder model. In other embodiments, the device further comprises an encoder neural network that operates concurrently with the metasurface layers to implement the variational autoencoder model. In some embodiments, the encoder neural network comprises a convolutional neural network architecture. In other embodiments, the metasurface layers transform the random input light intensity profiles into output images containing handwritten digits. In some of these embodiments, the output images comprise diverse categories of digits from 0 to 9. In still other embodiments, the metasurface layers transform the random input light intensity profiles into output images of objects. In some of these embodiments, the output images comprise diverse categories such as fashion objects. In other embodiments, the metasurface layers comprise dielectric nanostructures that control both amplitude and phase of incident light through spatial multiplexing. In yet other embodiments, the detector comprises a CCD camera that captures the diverse output images generated by the metasurface layers.

In a fourth aspect, the technology provides a method of operating a multiplexed metasurface optical neural network device as a generative model comprising projecting random input light intensity profiles derived from a standard Gaussian distribution onto metasurface layers of the device, the random input light intensity profiles representing latent variables, modifying amplitude and phase of the random input light intensity profiles through the metasurface layers using spatial multiplexing, transforming the random input light intensity profiles into output images containing predetermined types of information through light propagation, and capturing the output images using a detector.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a multiplexed metasurface optical neural network device, according to aspects of the present disclosure.

FIG. 2 shows a flowchart depicting operational steps for wavelength multiplexing classification, according to an embodiment.

FIG. 3 illustrates the multiplexed metasurface optical neural network device operating as a generative model, according to aspects of the present disclosure.

FIG. 4 shows a flowchart depicting operational steps for generative model functionality, according to an embodiment.

FIG. 5 presents a flowchart for training the multiplexed metasurface layers, according to aspects of the present disclosure.

FIG. 6 illustrates a flowchart for configuring the multiplexed metasurface optical neural network device, according to an embodiment.

FIG. 7 shows a flowchart for training a generative model using the device, according to aspects of the present disclosure.

FIG. 8 presents a flowchart for real-time operation switching of the device, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Artificial neural networks have become widely used for processing and understanding massive amounts of data in various applications. However, traditional electronic implementations of artificial neural networks face limitations in terms of power consumption and processing speed. Optical neural networks offer potential advantages in power efficiency, speed, parallelism, bandwidth, and scalability compared to electronic counterparts. Despite their promise, existing optical neural network implementations face several challenges that limit their practical utility, including constraints on the number of functions that can be performed simultaneously and difficulties in scaling to handle diverse and complex tasks.

Multiplexed metasurface optical neural networks address these limitations by leveraging metasurfaces that consist of nanostructures designed by machine learning and optimization algorithms. These metasurfaces possess the capability to precisely control both the amplitude and phase of incident light, enabling all-optical image classification and pattern generation at specific wavelengths and polarizations. The metasurfaces may be fabricated using dielectric or metallic nanostructures that operate at optical wavelengths in the visible to infrared spectrum and respond to different polarization states. In some cases, the multiplexed approach allows a single device to perform multiple distinct neural network functions simultaneously using different degrees of freedom such as wavelengths and polarizations as multiplexing channels.

The multiplexed metasurface optical neural networks may operate in two distinct modes. In some cases, the networks function as classification systems that can perform multiple distinct classification tasks, with each task associated with a different degree of freedom of the incident light. The networks may also operate as generative models that transform random input light intensity profiles into diverse output images containing predetermined types of information. This dual functionality enables applications ranging from parallel image recognition to optical encryption schemes by encoding and decoding sensitive information through the manipulation of light propagation through the metasurface layers.

Training of multiplexed metasurface optical neural networks may be accomplished through independent optimization for each multiplexing channel including wavelength and polarization channels. The training process involves multiple iterations using Fresnel diffraction calculations to optimize the amplitude and phase profiles of the metasurface layers. This approach simplifies the inverse design problem of individual meta-atoms while enabling the networks to achieve high classification accuracies across different wavelength and polarization channels. The compact footprint of these networks at the nanometer scale provides advantages over bulky centimeter-scale implementations that operate in other frequency bands.

The following detailed description, taken in conjunction with the accompanying drawings, provides a more complete understanding of the nature and advantages of the multiplexed metasurface optical neural networks. The drawings illustrate various embodiments and implementations of the networks, including device configurations, operational methods, and training procedures that enable the multiplexed functionality across different optical channels.

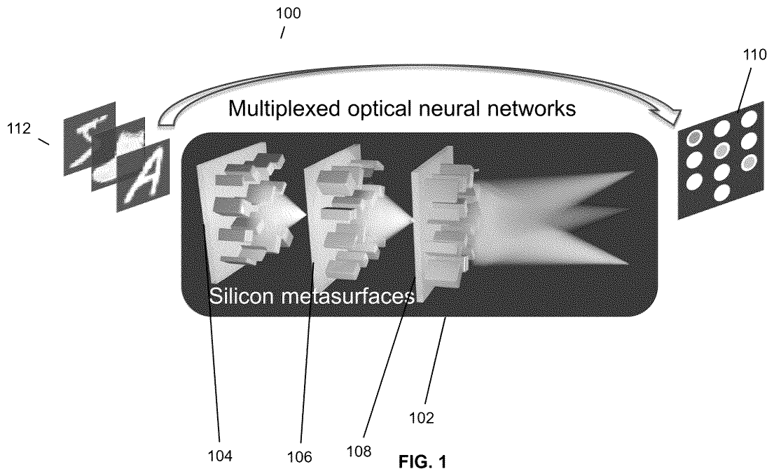

FIG. 1 illustrates a multiplexed metasurface optical neural network device 100 according to various embodiments. The multiplexed metasurface optical neural network device 100 includes a plurality of metasurface layers 102 that modify the amplitude and phase of the incident light to perform multiple distinct classification tasks. Each classification task may be associated with a different degree of freedom of the incident light, such as wavelength or polarization. The plurality of metasurface layers 102 enables the multiplexed metasurface optical neural network device 100 to encode between 6 and 12 functional channels, or more, within a single device, advancing parallel classification capabilities across multiple optical channels including wavelength and polarization channels simultaneously.

As shown in FIG. 1, the plurality of metasurface layers 102 comprises a first metasurface layer 104, a second metasurface layer 106, and a third metasurface layer 108 arranged sequentially along an optical path, although the number of layers may be fewer or greater than three. Each of the metasurface layers may have distinct amplitude and phase profiles optimized for wavelength multiplexing or polarization multiplexing operations. The first metasurface layer 104, second metasurface layer 106, and third metasurface layer 108 work in combination to process input images 112 that are projected onto the multiplexed metasurface optical neural network device 100. The metasurface layers may comprise dielectric nanostructures or metallic nanostructures that control both amplitude and phase of the incident light to enable all-optical image classification at different wavelengths or polarization states. In some cases, the nanostructures are designed by machine learning and optimization algorithms to achieve performance for specific classification tasks.

The multiplexed metasurface optical neural network device 100 includes a detector 110 that captures output intensity information encoding classification weights for each of the plurality of distinct classification tasks. The detector 110 may comprise a CCD camera that captures intensity information encoding digit weights or other classification parameters. In some cases, a first wavelength or polarization state, for example about 700 nm or linear polarization, performs handwritten digit recognition while a second wavelength or polarization state, for example about 1100 nm or circular polarization, performs object classification using the same plurality of metasurface layers 102. Thus, the multiplexed metasurface optical neural network device 100 may process different types of classification tasks simultaneously through wavelength multiplexing or polarization multiplexing.

The metasurface layers may be trained independently for each wavelength or polarization state by optimizing amplitude and phase modifications through multiple iterations using Fresnel diffraction calculations. This training approach allows each of the metasurface layers to develop specialized amplitude and phase profiles that are optimized for the specific wavelength multiplexing or polarization multiplexing requirements. The multiplexed metasurface optical neural network device 100 may leverage polarizations as multiplexing channels in addition to wavelengths, providing additional degrees of freedom for performing distinct classification tasks. The compact footprint of the multiplexed metasurface optical neural network device 100 at the nanometer scale provides advantages over bulky centimeter-scale terahertz implementations, enabling more practical deployment in various applications.

The multiplexed metasurface optical neural network device 100 may be implemented using integrated photonic platforms that provide enhanced scalability and manufacturing compatibility. The integrated photonic implementation allows for precise control of the optical properties while maintaining the compact form factor. The plurality of metasurface layers 102 processes the input images 112 through sequential amplitude and phase modifications, with each layer contributing to the overall classification performance. The detector 110 captures the resulting optical signals after the light has propagated through all metasurface layers, providing output intensity information that encodes the classification results for multiple distinct tasks simultaneously through the multiplexed operation of the multiplexed metasurface optical neural network device 100.

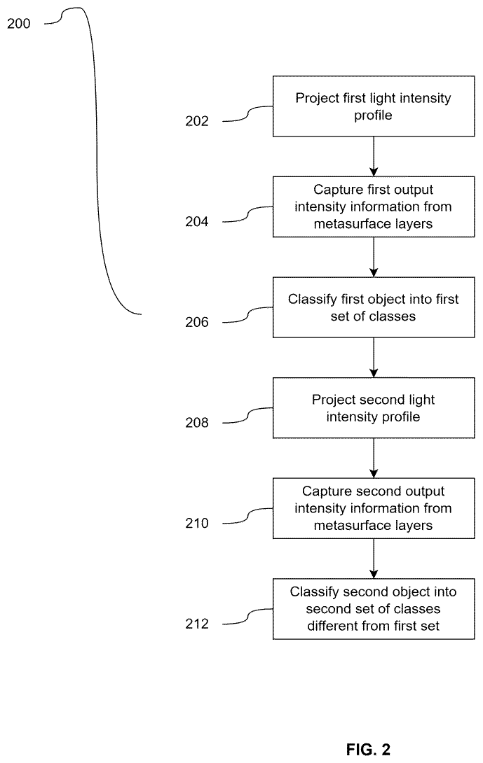

FIG. 2 illustrates a method for operating the multiplexed metasurface optical neural network device 100 using wavelength multiplexing or polarization multiplexing for classification tasks according to various embodiments. The method enables the multiplexed metasurface optical neural network device 100 to perform multiple distinct classification tasks simultaneously by utilizing different wavelengths of light or different polarization states as multiplexing channels. The wavelength multiplexing or polarization multiplexing operation allows the same plurality of metasurface layers 102 to process different types of objects and classify them into different sets of classes based on the wavelength or polarization state of the incident light. The method provides a systematic approach for leveraging the wavelength-dependent or polarization-dependent optical properties of the first metasurface layer 104, second metasurface layer 106, and third metasurface layer 108 to achieve parallel classification capabilities across multiple optical channels.

The method begins with a step 200 that involves projecting a first light intensity profile representing a first object onto the plurality of metasurface layers 102 using a first degree of freedom of light. An input image pattern 202 represents the first object that is to be classified by the multiplexed metasurface optical neural network device 100. The first degree of freedom may be a wavelength of about 700 nm or a specific polarization state such as linear polarization, which operates within the visible to infrared spectrum range or utilizes polarization multiplexing capabilities. The input image pattern 202 carries the optical information that will be processed through the plurality of metasurface layers 102. The metasurface layers modify both amplitude and phase of the incident light as the input image pattern 202 propagates through the optical system.

A step 202 involves capturing first output intensity information from the plurality of metasurface layers 102 corresponding to classification of the first object into a first set of classes. An output image pattern 204 represents the processed optical information after the light has propagated through all metasurface layers. The detector 110 captures the first output intensity information that encodes classification weights for the first set of classes. In some cases, the first set of classes comprises handwritten digits, allowing the multiplexed metasurface optical neural network device 100 to distinguish between different numerical characters. The detector 110 may comprise a CCD camera that captures intensity information encoding digit weights or other classification parameters. The output image pattern 204 contains the optical signatures that correspond to the classification results for the handwritten digit recognition task performed at the 700 nm wavelength.

A step 204 involves classifying the first object based on the first output intensity information captured by the detector 110. The classification process analyzes the intensity patterns within the output image pattern 204 to determine which specific class within the first set of classes to which the first object belongs. Each of the metasurface layers has distinct amplitude and phase profiles optimized independently for a chosen wavelength or polarization state through Fresnel diffraction calculations. The optimization process involves multiple iterations of the same meta-ONN model using different wavelengths or polarization states in Fresnel diffraction calculations to achieve the desired classification performance.

A step 206 involves projecting a second light intensity profile representing a second object onto the plurality of metasurface layers 102 using a second degree of freedom of light different from the first degree of freedom. The second degree of freedom may be a wavelength of about 1100 nm or a different polarization state such as circular polarization, which also operates within the visible to infrared spectrum or utilizes different polarization multiplexing capabilities but provides different optical interactions with the metasurface layers compared to the first wavelength or polarization state. The same plurality of metasurface layers 102 process the second light intensity profile, but the wavelength-dependent or polarization-dependent properties of the dielectric nanostructures result in different amplitude and phase modifications. The dielectric nanostructures control both amplitude and phase of the incident light and enable all-optical image classification through wavelength multiplexing or polarization multiplexing at the different wavelengths or polarization states. The second object represents a different type of input that will be classified into a second set of classes that is different from the first set of classes used for handwritten digit recognition.

A step 208 involves capturing second output intensity from the plurality of metasurface layers 102 corresponding to classification of the second object into a second set of classes different from the first set of classes. The detector 110 captures the second output intensity information after the second degree of freedom of light has propagated through the metasurface layers. In some cases, the second set of classes comprises objects, enabling the multiplexed metasurface optical neural network device 100 to perform object classification using the second degree of freedom. The CCD camera captures intensity information encoding classification weights that correspond to the different object categories within the second set of classes. The multiplexing operation allows the same physical metasurface layers to perform two distinct classification tasks simultaneously by utilizing the optical properties of the nanostructures to affect different degrees of freedom of the light including wavelength or polarization.

A step 210 involves classifying the second object based on the second output intensity captured by the detector 110. The classification process for the second object analyzes the intensity patterns generated by the second degree of freedom of light after propagation through the plurality of metasurface layers 102.

A step 212 represents the completion of the dual classification process, where both the handwritten digit recognition and object classification have been performed using the same multiplexed metasurface optical neural network device 100. The method may also extend to additional wavelengths or polarization states, such as blue light wavelength for English letter classification or elliptical polarization for additional classification tasks, further expanding the multiplexing capabilities of the optical neural network system. The wavelength multiplexing or polarization multiplexing operation provides a practical approach for implementing parallel classification capabilities within a single compact optical device.

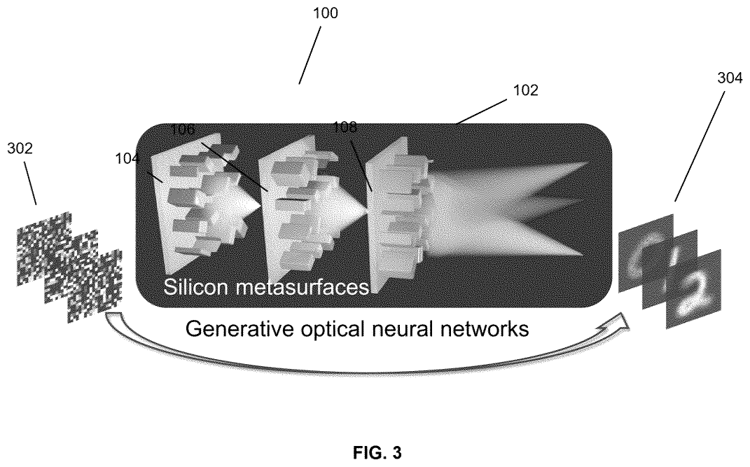

FIG. 3 illustrates a multiplexed metasurface optical neural network device 100 operating as a generative model according to various embodiments. The multiplexed metasurface optical neural network device 100 may operate as a decoder in a variational autoencoder model for image generation and optical encryption applications. The generative model configuration enables the multiplexed metasurface optical neural network device 100 to transform random input light intensity profiles 302 into diverse output images 304 through spatial multiplexing operations. The random input light intensity profiles 302 are derived from a standard Gaussian distribution representing latent variables in the generative model. The spatial multiplexing approach allows the plurality of metasurface layers 102 to process the random input light intensity profiles 302 and generate diverse output images 304 that contain predetermined types of information through controlled light propagation.

As shown in FIG. 3, the plurality of metasurface layers 102 comprises the first metasurface layer 104, the second metasurface layer 106, and the third metasurface layer 108 that work in combination to implement the generative model functionality. Although three metasurface layers are depicted in FIG. 3, the number of layers present in a device may be fewer or greater than three. Each of the metasurface layers may have distinct phase profiles optimized for the generative model through spatial multiplexing operations. The plurality of metasurface layers 102 modify both amplitude and phase of the incident light as the random input light intensity profiles 302 propagate through the optical system. The metasurface layers may comprise dielectric nanostructures that control both amplitude and phase of incident light through spatial multiplexing. The dielectric nanostructures enable the transformation of the random input light intensity profiles 302 into structured optical patterns that correspond to the diverse output images 304. The spatial multiplexing operation allows each metasurface layer to contribute specific amplitude and phase modifications that collectively produce the desired image generation capabilities.

The multiplexed metasurface optical neural network device 100 may include an encoder neural network that operates concurrently with the plurality of metasurface layers 102 to implement the variational autoencoder model. The encoder neural network may comprise a convolutional neural network architecture that processes input data and generates the random input light intensity profiles 302 for the optical decoder portion of the system. The convolutional neural network architecture provides the digital processing capabilities that complement the optical processing performed by the plurality of metasurface layers 102. The encoder neural network and the plurality of metasurface layers 102 work together to create a hybrid digital-optical system that combines the advantages of electronic neural networks with the parallel processing capabilities of optical systems. The variational autoencoder model implementation enables the multiplexed metasurface optical neural network device 100 to learn complex data distributions and generate new samples that follow the learned patterns.

The metasurface layers may transform the random input light intensity profiles 302 into the output images 304 containing handwritten digits through the spatial multiplexing operations. The transformation process involves the sequential processing of the random input light intensity profiles 302 through each of the plurality of metasurface layers 102, with each layer contributing specific optical modifications that collectively produce the output. The spatial multiplexing approach enables the plurality of metasurface layers 102 to generate diverse images after light propagates through the metasurface layers when illuminated with light carrying the random intensity profiles. The diversity of the output images 304 demonstrates the capability of the generative model to produce varied representations of handwritten digits based on different random input light intensity profiles 302 derived from the standard Gaussian distribution.

The detector 110 captures the diverse output images 304 generated by the plurality of metasurface layers 102 through the spatial multiplexing operations. The detector 110 may comprise a CCD camera that captures the diverse output images 304 after the light has propagated through all metasurface layers. The CCD camera provides the optical-to-electronic conversion that enables the capture and analysis of the generated images. The detector 110 records the intensity patterns that correspond to the handwritten digits or other image types produced by the generative model. The multiplexed metasurface optical neural network device 100 may enable novel optical encryption schemes by encoding and decoding sensitive information through the manipulation of the random input light intensity profiles 302 and the resulting output images 304. The optical encryption capability arises from the complex relationship between the input random patterns and the generated output images, which may be difficult to reverse-engineer without knowledge of the specific metasurface layer configurations and the trained parameters of the variational autoencoder model.

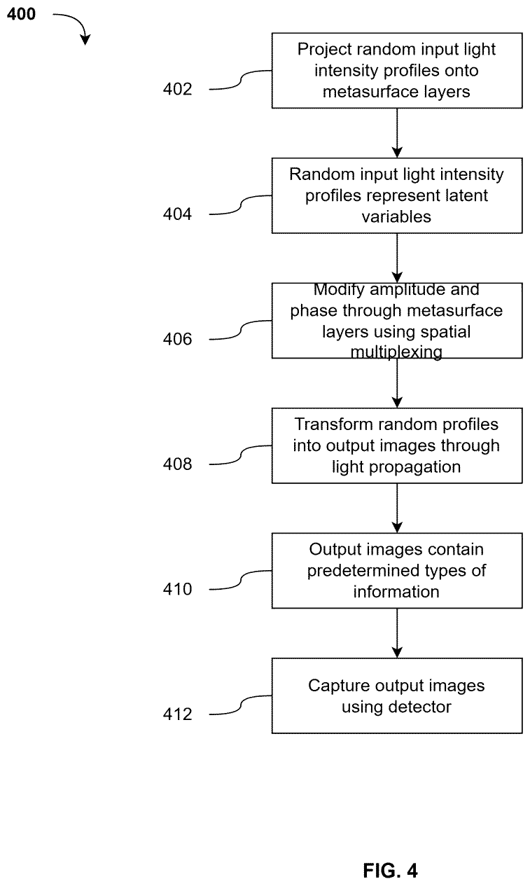

FIG. 4 illustrates a method 400 for operating the multiplexed metasurface optical neural network device 100 as a generative model according to various embodiments. The method 400 enables the multiplexed metasurface optical neural network device 100 to transform the random input light intensity profiles 302 into the output images 304 through spatial multiplexing operations that modify both amplitude and phase characteristics of the incident light. The generative model operation provides a systematic approach for utilizing the plurality of metasurface layers 102 to generate diverse images containing predetermined types of information based on latent variable inputs derived from statistical distributions. The method 400 leverages the spatial multiplexing capabilities of the first metasurface layer 104, second metasurface layer 106, and third metasurface layer 108 to achieve controlled image generation through optical processing of random intensity patterns.

The method 400 begins with a step 402 that involves projecting the random input light intensity profiles 302 derived from a standard Gaussian distribution onto the plurality of metasurface layers 102 of the multiplexed metasurface optical neural network device 100. The random input light intensity profiles 302 serve as the initial optical inputs that carry the statistical characteristics needed for the generative model operation. The standard Gaussian distribution provides the mathematical foundation for generating diverse input patterns that enable the creation of varied output images through the spatial multiplexing process. The projection of the random input light intensity profiles 302 onto the first metasurface layer 104 initiates the optical processing sequence that transforms the statistical input patterns into structured optical signals. The random nature of the input light intensity profiles allows the generative model to produce diverse output images that span the range of possible image types that the plurality of metasurface layers 102 has been trained to generate.

A step 404 involves configuring the random input light intensity profiles 302 to represent latent variables in the generative model framework. The latent variables encode the underlying statistical properties that determine the characteristics of the output images 304 generated by the spatial multiplexing operations. The random input light intensity profiles 302 function as optical representations of the latent variables, providing the input data that drives the image generation process through the plurality of metasurface layers 102. The latent variable representation allows the method 400 to generate diverse output images by sampling different random input light intensity profiles 302 from the standard Gaussian distribution. The spatial distribution and intensity characteristics of the random input light intensity profiles 302 determine the specific features and patterns that will appear in the output images 304 after processing through the first metasurface layer 104, second metasurface layer 106, and third metasurface layer 108.

A step 406 involves modifying amplitude and phase of the random input light intensity profiles 302 through the plurality of metasurface layers 102 using spatial multiplexing operations. The spatial multiplexing approach enables each of the metasurface layers to apply specific amplitude and phase modifications to the optical signals as they propagate through the multiplexed metasurface optical neural network device 100. The first metasurface layer 104 applies initial amplitude and phase modifications to the random input light intensity profiles 302, creating intermediate optical patterns that carry enhanced structural information compared to the original random inputs. The second metasurface layer 106 further processes the optical signals by applying additional amplitude and phase modifications that refine the spatial patterns and enhance the image formation process. The third metasurface layer 108 completes the spatial multiplexing sequence by applying final amplitude and phase modifications that produce the structured optical patterns corresponding to the desired output images 304.

A step 408 involves transforming the random input light intensity profiles 302 into the output images 304 containing predetermined types of information through light propagation within the multiplexed metasurface optical neural network device 100. The transformation process utilizes the combined effects of the amplitude and phase modifications applied by the first metasurface layer 104, second metasurface layer 106, and third metasurface layer 108 to convert the random optical patterns into structured image data. The light propagation through the plurality of metasurface layers 102 enables the spatial multiplexing operations to gradually transform the statistical characteristics of the random input light intensity profiles 302 into the specific features and patterns that define the output images 304. The predetermined types of information contained in the output images 304 may include handwritten digits, objects, fashion products or other image categories that the generative model has been trained to produce through the spatial multiplexing approach. The transformation process demonstrates the capability of the plurality of metasurface layers 102 to perform complex optical processing operations that convert random input patterns into meaningful image content.

A step 410 involves capturing the output images 304 using the detector 110 after the light propagation and spatial multiplexing operations have been completed. The detector 110 records the optical intensity patterns that correspond to the generated images produced by the transformation of the random input light intensity profiles 302 through the plurality of metasurface layers 102. The capturing process converts the optical signals into electronic data that represents the output images 304 containing the predetermined types of information generated by the spatial multiplexing operations. The detector 110 may comprise a CCD camera or other optical sensing device that provides the optical-to-electronic conversion needed to record and analyze the generated images. A step 412 represents the completion of the generative model operation, where the method 400 has successfully transformed the random input light intensity profiles 302 into the output images 304 through the spatial multiplexing capabilities of the multiplexed metasurface optical neural network device 100. The method 400 may be repeated with different random input light intensity profiles 302 to generate additional diverse output images, demonstrating the versatility of the generative model approach in producing varied image content from statistical input distributions.

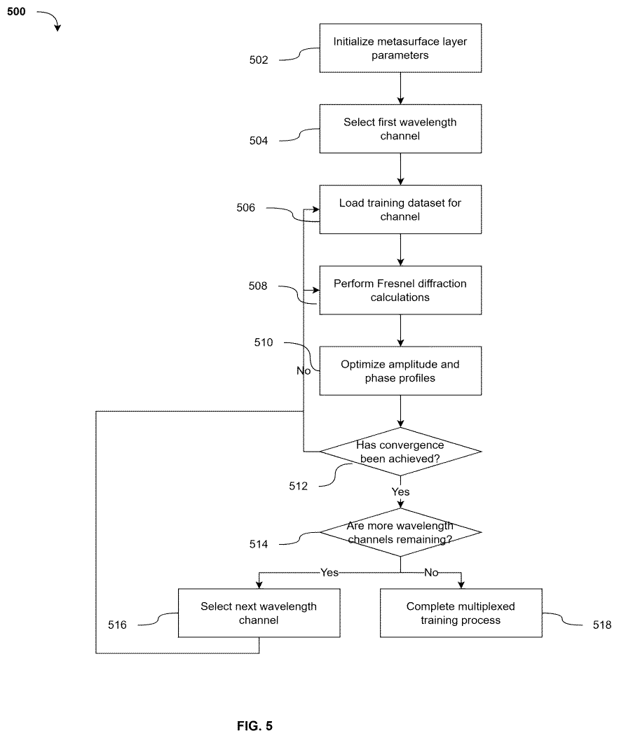

FIG. 5 illustrates a method 500 for training the plurality of metasurface layers 102 in the multiplexed metasurface optical neural network device 100 according to various embodiments. The method 500 provides a systematic approach for optimizing the amplitude and phase profiles of the plurality of metasurface layers 102 across multiple wavelength channels through iterative optimization processes. The training methodology enables each wavelength channel to be optimized independently while maintaining the overall multiplexed functionality of the multiplexed metasurface optical neural network device 100. The method 500 utilizes Fresnel diffraction calculations to model the optical propagation through the plurality of metasurface layers 102 and optimize the nanostructure parameters for each specific wavelength channel. The iterative optimization process allows the training methodology to converge on optimal amplitude and phase profiles that maximize classification accuracy for each distinct classification task associated with different wavelength channels.

The method 500 begins with a step 502 that involves initializing metasurface layer parameters for the plurality of metasurface layers 102. The initialization process establishes starting values for the amplitude and phase profiles of each metasurface layer before the iterative optimization begins. The metasurface layer parameters may include the geometric properties of the dielectric nanostructures or metallic nanostructures that comprise each layer. In some cases, the initialization process uses random parameter values or predetermined patterns that provide a suitable starting point for the optimization algorithm. The step 502 establishes the foundation for the training process by defining the initial state of the plurality of metasurface layers 102 before wavelength-specific optimization begins.

A step 504 involves selecting a first multiplexing channel for the iterative optimization process. The channel selection determines which specific optical property will be used for the current optimization iteration. In some cases, the first multiplexing channel may correspond to a wavelength falling within the visible to near infrared portion of the spectrum. The step 504 establishes the optical parameters that will be used in the Fresnel diffraction calculations during the current optimization cycle. The wavelength channel selection process enables the method 500 to focus on optimizing the amplitude and phase profiles for one specific multiplexing channel at a time, simplifying the optimization problem while maintaining the overall multiplexed functionality.

A step 506 involves loading a training dataset for the selected multiplexing channel. The training dataset contains the input images 112 and corresponding target classifications that will be used to optimize the metasurface layer parameters for the current channel. In some cases, the training dataset for the 700 nm wavelength channel may contain handwritten digit images, while the training dataset for the 1100 nm wavelength channel may contain object images. The step 506 provides the ground truth data that guides the optimization process by defining the desired input-output relationships for the current channel. The training dataset enables the method 500 to evaluate the performance of the current metasurface layer parameters and determine the direction for parameter updates during the optimization process.

A step 508 involves performing Fresnel diffraction calculations to model the optical propagation through the plurality of metasurface layers 102 for the current wavelength channel. The Fresnel diffraction calculations simulate how light propagates through the first metasurface layer 104, second metasurface layer 106, and third metasurface layer 108 based on the current amplitude and phase profiles. The calculations account for the wavelength-dependent optical properties of the nanostructures and the spatial distribution of the optical fields as they propagate through each metasurface layer. The step 508 provides the forward modeling capability that enables the method 500 to predict the optical output of the multiplexed metasurface optical neural network device 100 for given input conditions and metasurface layer parameters. The Fresnel diffraction calculations form the mathematical foundation for evaluating the performance of the current metasurface layer configurations and determining the parameter updates needed to improve classification accuracy.

A step 510 involves optimizing the amplitude and phase profiles of the plurality of metasurface layers 102 based on the results of the Fresnel diffraction calculations. The optimization process adjusts the parameters of the first metasurface layer 104, second metasurface layer 106, and third metasurface layer 108 to minimize the difference between the predicted optical output and the desired classification results from the training dataset. The amplitude and phase profile optimization may utilize gradient-based optimization algorithms that calculate the parameter updates needed to improve the classification performance. In some cases, the optimization process adjusts the geometric properties of the dielectric nanostructures or metallic nanostructures to achieve the desired optical modifications for the current wavelength channel. The step 510 implements the core learning mechanism that enables the plurality of metasurface layers 102 to adapt their optical properties to perform the desired classification tasks with high accuracy.

A step 512 involves determining whether convergence has been achieved for the current wavelength channel optimization. The convergence evaluation assesses whether the classification accuracy has reached a satisfactory level or whether the parameter updates have become sufficiently small to indicate that further optimization iterations will not provide substantial improvements. If convergence has not been achieved, the method 500 returns to the step 508 to perform additional Fresnel diffraction calculations with the updated metasurface layer parameters. The iterative loop between the step 508, step 510, and step 512 continues until the optimization process converges on optimal amplitude and phase profiles for the current wavelength channel.

If convergence has been achieved for the current wavelength channel, the method 500 proceeds to a step 514 that involves determining whether additional wavelength channels remain to be optimized. The step 514 evaluates whether all desired wavelength channels have been processed through the iterative optimization process or whether additional channels require training. In some cases, the multiplexed metasurface optical neural network device 100 may support multiple channels beyond the 700 nm and 1100 nm wavelength channels, such as blue light wavelength or circular polarization. If additional multiplexing channels remain, the method 500 proceeds to a step 516 that involves selecting the next wavelength channel for optimization. The step 516 updates the wavelength parameters that will be used in subsequent Fresnel diffraction calculations and returns the method 500 to the step 506 to load the appropriate training dataset for the new wavelength channel.

If no additional multiplexing channels remain to be optimized, the method 500 concludes with a step 518 that represents the completion of the multiplexed training process. The step 518 indicates that all desired wavelength channels have been optimized and that the plurality of metasurface layers 102 have been trained to perform multiple distinct classification tasks through metasurface multiplexing. The completed training process results in optimized amplitude and phase profiles for the plurality of metasurface layers 102 that enable the multiplexed metasurface optical neural network device 100 to achieve high classification accuracies across all trained multiplexing channels. The method 500 demonstrates how the independent optimization approach for each wavelength channel simplifies the inverse design problem while enabling the multiplexed metasurface optical neural network device 100 to perform parallel classification capabilities across multiple optical channels simultaneously.

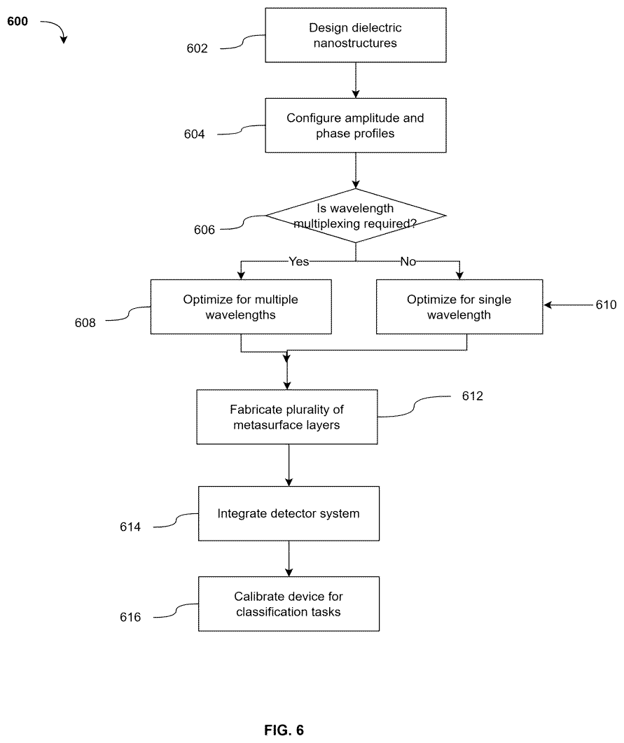

FIG. 6 illustrates a method 600 for configuring the multiplexed metasurface optical neural network device 100 according to various embodiments. The method 600 provides a systematic approach for fabricating and configuring the plurality of metasurface layers 102 to achieve the desired optical properties for wavelength multiplexing and spatial multiplexing operations. The configuration process encompasses the design and fabrication of the dielectric nanostructures or metallic nanostructures that comprise the plurality of metasurface layers 102. The method 600 enables the optimization of amplitude and phase profiles across multiple wavelength channels while integrating the detector 110 system for capturing output intensity information. The configuration methodology allows for the implementation of both classification and generative model functionalities within the same multiplexed metasurface optical neural network device 100 through careful design of the metasurface layer parameters and optical system components.

The method 600 begins with a step 602 that involves designing the dielectric nanostructures or metallic nanostructures that will comprise each of the plurality of metasurface layers 102. The design process utilizes machine learning and optimization algorithms to determine the geometric parameters for each nanostructure element within the plurality of metasurface layers 102. The nanostructure design may include parameters such as width, height, spacing, and orientation that determine the amplitude and phase modifications applied to incident light at different multiplexing channels. In some cases, the design process involves electromagnetic simulations that model the optical response of individual nanostructures and their collective behavior within each metasurface layer. The step 602 enables the creation of nanostructure arrays that provide the wavelength-dependent optical properties needed for multiplexed classification tasks and generative model operations. The design optimization process may account for manufacturing tolerances and material properties to ensure that the fabricated nanostructures achieve the desired optical performance across the visible to infrared spectrum.

A step 604 involves configuring amplitude and phase profiles for the plurality of metasurface layers 102 based on the nanostructure designs and the desired optical functionalities. The configuration process establishes the spatial distribution of amplitude and phase modifications that each metasurface layer will apply to incident light for different wavelength channels. The amplitude and phase profiles may be optimized independently for each wavelength channel to achieve the desired classification accuracies or generative model performance. In some cases, the configuration process involves mapping the electromagnetic response of the designed nanostructures to the required amplitude and phase modifications for specific optical functions. The step 604 enables the plurality of metasurface layers 102 to perform wavelength multiplexing operations by providing different optical responses for the first wavelength and the second wavelength. The configuration process may also account for additional wavelength channels such as blue light wavelength for English letter classification when extended multiplexing capabilities are desired.

The method 600 proceeds to a step 606 that involves determining whether wavelength multiplexing functionality is required for the specific application of the multiplexed metasurface optical neural network device 100. The decision point evaluates the operational requirements and determines the appropriate optimization approach for the amplitude and phase profiles of the plurality of metasurface layers 102. The step 606 enables the method 600 to branch into different optimization pathways based on whether the multiplexed metasurface optical neural network device 100 will perform multiple distinct classification tasks using different wavelength channels or operate with a single wavelength channel for specific applications. The decision process may consider factors such as the number of classification tasks, the available optical sources, and the complexity of the detector 110 system when determining the appropriate configuration approach.

If wavelength multiplexing is required, the method 600 proceeds to a step 608 that involves performing optimization for multiple wavelengths to achieve the desired optical properties across all wavelength channels. The multi-wavelength optimization process adjusts the amplitude and phase profiles of the plurality of metasurface layers 102 to achieve high classification accuracies for each distinct classification task associated with different wavelengths. The step 608 may utilize iterative optimization algorithms that account for the wavelength-dependent optical properties of the nanostructures and the coupling effects between different wavelength channels. In some cases, the multi-wavelength optimization process involves sequential optimization of each wavelength channel followed by joint optimization to minimize cross-talk between channels and maximize overall system performance. The optimization process may target specific performance metrics such as achieving accuracy for handwritten digit recognition in excess of a predetermined threshold or accuracy for object classification in excess of a predetermined threshold.

If multiplexing is not required, the method 600 proceeds to a step 610 that involves performing optimization for a single wavelength to achieve the desired optical properties for the specific application. The single-wavelength optimization process focuses on maximizing the performance of the plurality of metasurface layers 102 for one specific wavelength without considering the constraints imposed by multiple wavelength operations. The step 610 may enable higher performance for single-wavelength applications by allowing the amplitude and phase profiles to be optimized without the trade-offs associated with wavelength multiplexing operations. In some cases, the single-wavelength optimization may be used for specialized applications such as high-accuracy handwritten digit recognition or dedicated generative model operations that do not require multiple classification tasks. The optimization process may achieve higher classification accuracies or better generative model performance compared to multiplexed configurations due to the focused optimization approach.

Both the step 608 and the step 610 lead to a step 612 that involves fabricating the plurality of metasurface layers 102 using nanofabrication techniques suitable for creating the dielectric nanostructures or metallic nanostructures. The fabrication process may utilize optical lithography, electron beam lithography, or two-photon polymerization methods to create the nanostructures with the precise geometric properties needed for wavelength multiplexing operations. The step 612 establishes the physical foundation of the multiplexed metasurface optical neural network device 100 by creating the metasurface layers 102 with the appropriate material properties and structural dimensions. In some cases, the fabrication process involves depositing dielectric materials such as silicon, titanium dioxide, or gallium phosphide onto substrates to form the nanostructure arrays. The fabrication step may also include the creation of metallic nanostructures using materials such as gold, silver, or aluminum when metallic implementations are desired for specific wavelength ranges or optical properties.

The method 600 continues to a step 614 that involves integrating the detector 110 system into the multiplexed metasurface optical neural network device 100 configuration. The detector integration process establishes the optical and electronic interfaces needed to capture the output intensity information from the plurality of metasurface layers 102. The detector 110 may comprise a CCD camera or other optical sensing device that provides the spatial resolution and sensitivity needed to capture the intensity patterns generated by the wavelength, polarization or spatial multiplexing operations. In some cases, the detector integration process involves aligning the detector 110 with the optical output of the third metasurface layer 108 and configuring the electronic interfaces for data acquisition and processing. The step 614 may also include the integration of optical components such as lenses, filters, or beam splitters that enhance the optical coupling between the plurality of metasurface layers 102 and the detector 110 system. The detector integration process enables the capture of output intensity information encoding classification weights for multiple distinct classification tasks or the diverse output images 304 generated by the spatial multiplexing operations in generative model applications.

The method 600 concludes with a step 616 that involves calibrating the multiplexed metasurface optical neural network device 100 for the intended classification tasks or generative model operations. The calibration process verifies that the fabricated and configured system achieves the desired optical performance and classification accuracies across all operational multiplexing channels. The step 616 may involve testing the multiplexed metasurface optical neural network device 100 with known input images 112 and comparing the captured output intensity information with expected results to validate the system performance. In some cases, the calibration process includes fine-tuning of the detector 110 parameters, optical alignment adjustments, or minor modifications to the amplitude and phase profiles to optimize the overall system performance. The calibration step enables the verification of wavelength multiplexing capabilities by confirming that the same plurality of metasurface layers 102 can perform handwritten digit recognition at a first wavelength and object classification at a second wavelength with the target accuracies. The method 600 provides a comprehensive approach for configuring the multiplexed metasurface optical neural network device 100 from initial fabrication through final calibration, enabling the implementation of advanced optical neural network functionalities with compact footprint and enhanced parallel processing capabilities.

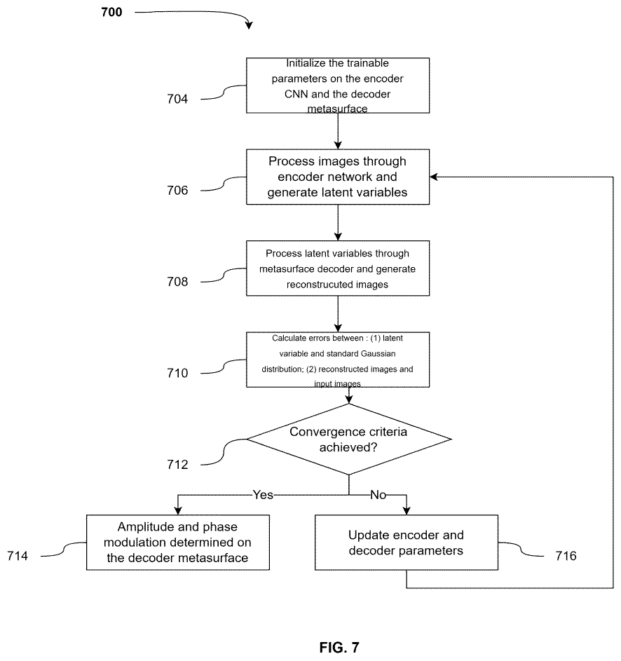

FIG. 7 illustrates a method 700 for training a generative model using the multiplexed metasurface optical neural network device 100 according to various embodiments. The method 700 provides a systematic approach for training both the encoder neural network components and the plurality of metasurface layers 102 to achieve generative model functionality that transforms the random input light intensity profiles 302 into the output images 304 through spatial multiplexing operations. The training methodology enables the concurrent optimization of digital encoder parameters and optical decoder parameters within the plurality of metasurface layers 102. The method 700 utilizes iterative parameter updates to achieve training convergence where the generated output images match target image distributions. The training process establishes the relationship between random Gaussian input profiles and structured optical outputs that enable the multiplexed metasurface optical neural network device 100 to operate as a decoder in variational autoencoder models for image generation applications.

The method 700 begins with a step 704 that involves initializing the trainable parameters on the encoder CNN and the decoder metasurface within the plurality of metasurface layers 102 to establish the starting optical parameters for the training process. The initialization process configures the amplitude and phase profiles of the plurality of metasurface layers 102 with initial parameter values that provide a foundation for iterative optimization. The metasurface decoder layer initialization may involve setting the geometric properties of the dielectric nanostructures or metallic nanostructures that comprise each layer to predetermined values or random configurations. In some cases, the initialization process accounts for the physical constraints of the nanofabrication processes and the optical properties of the materials used to construct the plurality of metasurface layers 102. The step 704 establishes the optical processing component that will be optimized concurrently with the encoder CNN architecture to achieve the desired generative model performance through spatial multiplexing operations.

A step 706 involves processing images through the encoder network and generating latent variables that represent the encoded features of the input images. The processing calculation applies the convolutional layers, activation functions, and other neural network components within the encoder CNN architecture to transform the images into intermediate latent representations. The encoder network processing may involve feature extraction, dimensionality reduction, and format conversion operations that prepare the latent variables for optical processing through the plurality of metasurface layers 102. This encoder processing step establishes the interface between the digital encoding components and the optical decoding components within the hybrid generative model architecture.

A step 708 involves processing the latent variables through the metasurface decoder and generating reconstructed images. The spatial multiplexing operations utilize the plurality of metasurface layers 102 to transform the encoded representations from the encoder network into optical patterns that correspond to the desired output images. The spatial multiplexing process applies amplitude and phase modifications to the optical signals as the signals propagate through each metasurface layer. In some cases, the spatial multiplexing operations involve complex optical transformations that gradually convert the encoded input patterns into structured image data through controlled light propagation. The step 708 implements the optical processing component that generates the output images 304 based on the encoded inputs from the encoder CNN architecture and the current parameter settings of the plurality of metasurface layers 102.

A step 710 involves calculating errors between: (1) latent variable and standard Gaussian distribution; and (2) reconstructed images and input images. The comparison process evaluates the similarity between the generated output images and the desired target images using metrics such as mean squared error, structural similarity, or other image quality measures. The step 710 also evaluates how well the latent variables conform to the standard Gaussian distribution that is required for proper variational autoencoder functionality. The error calculation provides the feedback mechanism that guides the training process by indicating whether the current parameter settings of the encoder CNN architecture and the plurality of metasurface layers 102 produce satisfactory results.

A step 712 involves determining whether convergence criteria has been achieved based on the calculated errors from step 710. The decision point evaluates whether the training process has achieved convergence or whether additional parameter updates are needed to improve the generative model performance. In some cases, the convergence evaluation may involve multiple performance metrics including image quality, diversity, and consistency across different random input profiles. The step 712 determines whether the training process has achieved the desired performance levels for transforming the random input light intensity profiles 302 into the output images 304.

If convergence criteria has been achieved, the method 700 proceeds to a step 714 that involves determining amplitude and phase modulation on the decoder metasurface. The step 714 represents the achievement of training convergence for the generative model, where the encoder CNN architecture and the plurality of metasurface layers 102 have been successfully trained to transform random Gaussian input profiles into the desired output images through the spatial multiplexing operations. The training convergence signifies that the hybrid digital-optical system can generate diverse images that follow the target distribution characteristics. The step 714 concludes the training process when the generative model achieves the desired performance levels.

If convergence criteria has not been achieved, the method 700 proceeds to a step 716 that involves updating encoder and decoder parameters to improve the generative model performance. The parameter update process adjusts the weights and biases within the encoder CNN architecture based on gradient information calculated from the comparison between generated outputs and target images. The step 716 also updates the amplitude and phase profiles of the plurality of metasurface layers 102 using optimization algorithms that account for the optical propagation characteristics and the spatial multiplexing requirements. In some cases, the parameter updates may utilize backpropagation algorithms for the digital components and specialized optimization techniques for the optical components that account for the physical constraints of the plurality of metasurface layers 102. The step 716 implements the learning mechanism that enables the generative model to gradually improve the quality and accuracy of the generated output images through iterative refinement of both digital and optical parameters. After completing the parameter updates, the method 700 returns to the step 706 to process images through the encoder network for the next training iteration, creating a feedback loop that continues until training convergence is achieved at the step 714.

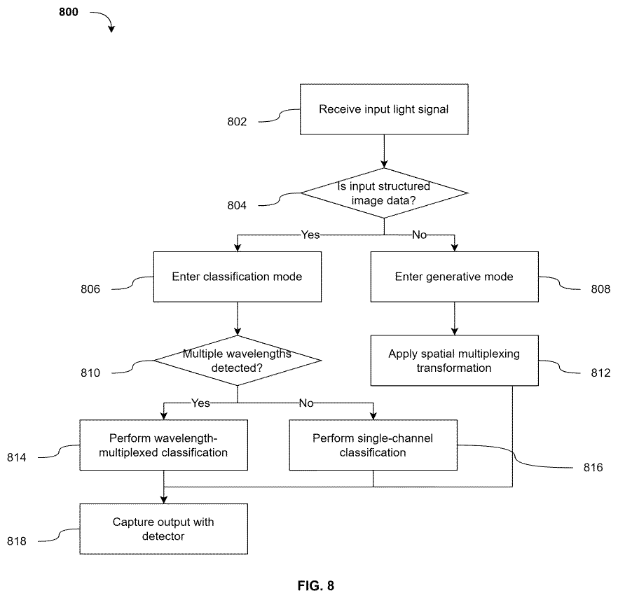

FIG. 8 illustrates a method 800 for real-time operation switching of the multiplexed metasurface optical neural network device 100 according to various embodiments. The method 800 enables the multiplexed metasurface optical neural network device 100 to automatically switch between classification and generative operational modes based on the characteristics of input optical signals. The real-time switching capability allows the same plurality of metasurface layers 102 to adapt their processing approach depending on whether the input corresponds to structured image data for classification tasks or random patterns for generative model operations. The method 800 provides a systematic decision-making process that evaluates input signal properties and configures the optical processing parameters of the plurality of metasurface layers 102 accordingly. The adaptive switching functionality enhances the versatility of the multiplexed metasurface optical neural network device 100 by enabling dynamic reconfiguration between different neural network functionalities without requiring physical modifications to the optical hardware components.

The method 800 begins with a step 802 that involves receiving an input light signal at the multiplexed metasurface optical neural network device 100. The input light signal may carry various types of optical information including structured image patterns for classification tasks or random intensity distributions for generative model operations. The step 802 establishes the initial interface between external optical sources and the plurality of metasurface layers 102 within the multiplexed metasurface optical neural network device 100. In some cases, the input light signal may be delivered through optical fibers, free-space propagation, or integrated photonic waveguides that couple the external optical information to the first metasurface layer 104. The reception process may involve optical conditioning components such as collimating lenses, polarization controllers, or beam shaping elements that prepare the input light signal for processing through the plurality of metasurface layers 102. The step 802 provides the foundation for the subsequent decision-making process by capturing the optical characteristics that will determine the appropriate operational mode for the multiplexed metasurface optical neural network device 100.

A step 804 involves determining whether the input light signal contains structured image data that corresponds to classification tasks. The determination process analyzes the spatial and temporal characteristics of the input light signal to identify patterns that indicate the presence of recognizable image content such as handwritten digits, fashion objects, or other classification targets. The step 804 may utilize optical or electronic analysis techniques that evaluate the coherence properties, intensity distributions, and spatial frequency content of the input light signal. In some cases, the determination process involves comparing the input signal characteristics against predetermined thresholds or pattern recognition algorithms that distinguish between structured image data and random intensity patterns. The decision-making process at the step 804 enables the method 800 to branch into different operational pathways based on the nature of the input optical information. The structured image data determination may account for various image formats and quality levels that correspond to different classification tasks supported by the wavelength multiplexing capabilities of the plurality of metasurface layers 102.

If the input light signal contains structured image data, the method 800 proceeds to a step 806 that involves configuring the multiplexed metasurface optical neural network device 100 to enter classification mode. The classification mode configuration establishes the operational parameters of the plurality of metasurface layers 102 for processing the input images 112 and generating classification results. The step 806 may involve setting the amplitude and phase profiles of the plurality of metasurface layers 102 to the trained configurations that correspond to specific classification tasks such as handwritten digit recognition, object or fashion product classification. In some cases, the classification mode configuration includes activating the detector 110 systems and signal processing algorithms that capture and analyze the output intensity information encoding classification weights. The classification mode enables the multiplexed metasurface optical neural network device 100 to achieve high classification accuracies by utilizing the optimized optical parameters that have been trained for specific wavelength channels and classification tasks.

If the input light signal does not contain structured image data, the method 800 proceeds to a step 808 that involves configuring the multiplexed metasurface optical neural network device 100 to enter generative mode. The generative mode configuration establishes the operational parameters for transforming the random input light intensity profiles 302 into the output images 304 through spatial multiplexing operations. The step 808 may involve setting the amplitude and phase profiles of the plurality of metasurface layers 102 to the trained configurations that enable the generative model functionality. In some cases, the generative mode configuration includes activating the encoder neural network components and the spatial multiplexing processing algorithms that work in conjunction with the optical decoder portion of the system. The generative mode enables the multiplexed metasurface optical neural network device 100 to produce diverse output images from random input patterns by utilizing the trained parameters that implement the variational autoencoder model functionality through the combined operation of digital and optical processing components.

From the step 806, the method 800 continues to a step 810 that involves detecting whether multiple wavelengths are present in the input light signal for classification operations. The wavelength detection process analyzes the spectral characteristics of the input light signal to determine whether wavelength multiplexing capabilities should be activated for parallel classification tasks. The step 810 may utilize optical spectroscopy techniques, wavelength-selective filters, or spectral analysis algorithms that identify the presence of multiple wavelength components within the input light signal. In some cases, the wavelength detection process evaluates whether the input contains both 700 nm wavelength components for handwritten digit recognition and 1100 nm wavelength components for fashion object classification. The detection process may also identify additional wavelength channels such as blue light wavelength for English letter classification when extended multiplexing capabilities are available. The step 810 enables the method 800 to adapt the classification processing approach based on the spectral content of the input light signal and the wavelength multiplexing capabilities of the plurality of metasurface layers 102.

If multiple wavelengths are detected in the classification mode, the method 800 proceeds to a step 814 that involves performing wavelength-multiplexed classification operations using the plurality of metasurface layers 102. The wavelength-multiplexed classification utilizes the trained amplitude and phase profiles of the plurality of metasurface layers 102 to process different classification tasks simultaneously across multiple wavelength channels. The step 814 enables the multiplexed metasurface optical neural network device 100 to achieve parallel processing capabilities by performing handwritten digit recognition at 700 nm wavelength and fashion product classification at 1100 nm wavelength using the same optical hardware. In some cases, the wavelength-multiplexed classification may include additional classification tasks such as English letter classification using blue light wavelength, expanding the parallel processing capabilities of the optical neural network system. The wavelength multiplexing operation demonstrates enhanced robustness in noisy real-world environments with additional layers beyond 3, as the efficiency defined as the ratio of intensity captured on the detector 110 plane to incident power continues to rise with more than 3 layers in the plurality of metasurface layers 102.

If multiple wavelengths are not detected in the classification mode, the method 800 proceeds to a step 816 that involves performing single-channel classification operations using the plurality of metasurface layers 102. The single-channel classification focuses the optical processing capabilities on one specific wavelength channel to achieve optimal performance for the detected classification task. The step 816 may utilize the trained parameters for either handwritten digit recognition at 700 nm wavelength or fashion object classification at 1100 nm wavelength depending on the spectral characteristics of the input light signal. In some cases, the single-channel classification may achieve higher accuracy levels compared to wavelength-multiplexed operations due to the focused optimization of the amplitude and phase profiles for the specific wavelength channel. The single-channel approach may be utilized when the input light signal contains only one wavelength component or when maximum classification accuracy is desired for a specific task rather than parallel processing capabilities across multiple classification categories.

From the step 808, the method 800 proceeds to a step 812 that involves applying spatial multiplexing transformation operations through the plurality of metasurface layers 102 for generative model functionality. The spatial multiplexing transformation utilizes the trained amplitude and phase profiles of the plurality of metasurface layers 102 to convert the random input light intensity profiles 302 into the output images 304. The step 812 implements the optical decoder portion of the variational autoencoder model by processing the random intensity patterns through sequential amplitude and phase modifications that gradually transform the statistical input characteristics into structured image content. In some cases, the spatial multiplexing transformation may work in conjunction with the encoder neural network components to implement the complete generative model functionality. The spatial multiplexing operations enable the multiplexed metasurface optical neural network device 100 to generate diverse output images containing predetermined types of information such as handwritten digits or other image categories based on the trained parameters of the plurality of metasurface layers 102.

The method 800 converges from the step 812, step 814, and step 816 to a step 818 that involves capturing output results using the detector 110 system. The step 818 provides the final interface between the optical processing operations and the electronic data acquisition systems that record the results of either classification or generative model operations. The detector 110 captures output intensity information encoding classification weights when the multiplexed metasurface optical neural network device 100 operates in classification mode, or captures the diverse output images 304 when the device operates in generative mode. In some cases, the step 818 may involve different detector configurations or signal processing algorithms depending on the operational mode selected by the real-time switching process. The output capture process completes the adaptive processing cycle by providing the electronic representation of the optical processing results that can be analyzed, stored, or transmitted for further processing. The method 800 demonstrates the versatility of the multiplexed metasurface optical neural network device 100 in adapting to different input characteristics and operational requirements through real-time switching between classification and generative functionalities while maintaining the compact footprint and enhanced processing capabilities enabled by the plurality of metasurface layers 102.

A number of implementations have been described. Nevertheless, it will be understood that various modifications may be made without departing from the spirit and scope of the disclosure. Accordingly, other implementations are within the scope of the following claims.

1. A multiplexed metasurface optical neural network device comprising:
one or more metasurface layers, each modifying one of amplitude and phase of incident light, the metasurface layers performing a plurality of distinct classification tasks, each task associated with a degree of freedom of the incident light; and
a detector that captures output intensity information encoding classification weights for each of the plurality of distinct classification tasks.

2. The device of claim 1, wherein each of the one or more metasurface layers has distinct amplitude and phase profiles optimized for wavelength multiplexing.

3. The device of claim 1 comprising three metasurface layers.

4. The device of claim 1, wherein the plurality of distinct classification tasks comprise more than six distinct classification tasks.

5. The device of claim 1, wherein the detector comprises a CCD camera that captures intensity information encoding digit weights.

6. The device of claim 1, wherein the metasurface layers are trained independently for each wavelength by optimizing amplitude and phase modifications through multiple iterations using Fresnel diffraction calculations.

7. The device of claim 1, wherein a first wavelength performs handwritten digit recognition and a second wavelength performs object classification.

8. The device of claim 7, wherein the first wavelength is about 700 nm and the second wavelength is about 1100 nm.

9. The device of claim 1, wherein the metasurface layers comprise dielectric nanostructures.

10. The device of claim 9, wherein the dielectric nanostructures control both amplitude and phase of the incident light to enable all-optical image classification at different wavelengths.

11. A method of operating a multiplexed metasurface optical neural network device comprising:
projecting a first light intensity profile representing a first object onto metasurface layers using a first wavelength of light;
capturing first output intensity information from the metasurface layers corresponding to classification of the first object into a first set of classes;
projecting a second light intensity profile representing a second object onto the metasurface layers using a second wavelength of light different from the first wavelength; and
capturing second output intensity information from the metasurface layers corresponding to classification of the second object into a second set of classes different from the first set of classes.

12. The method of claim 11, further comprising classifying the first object based on the first output intensity information and classifying the second object based on the second output intensity information.

13. The method of claim 11, wherein the first wavelength is 700 nm and the second wavelength is 1100 nm.

14. The method of claim 13, wherein the first set of classes comprises handwritten digits and the second set of classes comprises objects.

15. The method of claim 11, wherein the metasurface layers comprise one or more metasurface layers that modify both amplitude and phase of the incident light.

16. The method of claim 15, wherein each of the one or more metasurface layers has distinct amplitude and phase profiles optimized independently for each wavelength through Fresnel diffraction calculations.

17. The method of claim 11, wherein capturing the first output intensity information and capturing the second output intensity information comprises using a CCD camera that captures intensity information encoding classification weights.

18. The method of claim 11, wherein the metasurface layers comprise dielectric nanostructures that control both amplitude and phase of the incident light.

19. The method of claim 18, wherein the dielectric nanostructures enable all-optical image classification through wavelength multiplexing at the different wavelengths.
